(19) United States
(12) Patent Application Publication
(10) Pub. No.: US 2010/0051517 A1
(43) Pub. Date: Mar. 4, 2010

(54) ACTUATION AND PUMPING WITH FIELD-RESPONSIVE FLUIDS

(75) Inventors: Murat Ocalan, Boston, MA (US); Nathan Wicks, Somerville, MA (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/201,699

(22) Filed: Aug. 29, 2008

(51) Int. Cl. B03C 1/24; B07C 5/344

(52) U.S. Cl. 209/232; 209/539; 209/509

(57) ABSTRACT

Actuators, pumps, clutches, brakes and other assemblies may utilize field-responsive fluids that include a plurality of particles suspended in a base fluid. A positive displacement pump is provided by causing particles to align into chains and walls which inhibit traversal by fluid within a fluid enclosure. The field which aligns the particles is moved, thereby causing the walls of aligned particles to move. Because traversal of the walls by the fluid is inhibited, fluid is displaced by movement of the walls of aligned particles. A reciprocating positive displacement pump can be provided by ceasing particle alignment and returning the particles to a starting position. Objects may also be moved in response to collision with chains or walls of aligned particles that move in response to field movement. Fluid circulation features are provided for preventing agglomeration of particles when translating torque between plates in relative rotational movement.

### FIELD OF THE INVENTION

This invention is generally related to field-responsive fluids, and more particularly to mechanical actuators and pumps which are operated by manipulation of magnetorheological and electrorheological fluids.

### BACKGROUND OF THE INVENTION

Magnetorheological fluids typically comprise magnetically responsive particles suspended in a base fluid. An additive may be used to help maintain the particles in suspension in the base fluid and help prevent agglomeration. In the absence of a magnetic field, the magnetorheological fluid behaves similar to a Newtonian fluid. However, in the presence of a magnetic field the particles suspended in the base fluid align and form particle chains which are approximately parallel to the magnetic lines of flux associated with the field. Another effect of the magnetic field is to cause the fluid to enter a semi-solid state which exhibits increased resistance to shear. Resistance to shear is increased due to the magnetic attraction between particles of the chains. Adjacent chains of particles combine to form a sealing wall. The effect induced by the magnetic field is both reversible and repeatable by deactivating and reactivating the magnetic field. Electroheological fluids are analogous, although responsive to an electric field rather than a magnetic field.

Magnetorheological fluids are commonly used to provide resistance to external force. For example, magnetorheological fluids are used in dampers and brakes to provide resistive force. R. Rizzo, N. Sgambelluri, E. P. Scilingo, M. Raugi, and A. Bicchi, “Electromagnetic Modeling and Design of Haptic Interface Prototypes Based on Magnetorheological Fluids,” IEEE Transactions On Magnetics, Vol. 43, No. 9, September 2007 describes use of magnetorheological fluid for haptic devices. However, the tendency of the suspended particles to agglomerate as a result of applied force and differences in density relative to the base fluid is a problem that limits the use of magnetorheological fluids in applications such as dampers, brakes, haptic devices, and other components.

### SUMMARY OF THE INVENTION

In accordance with an embodiment of the invention, apparatus for moving a material within an enclosure comprises: a field-responsive fluid including a plurality of particles suspended in a base fluid, the field-responsive fluid disposed in the enclosure; a field generating source which generates a field in response to which at least some of the plurality of particles align, the field being moved relative to the enclosure and thereby cause the aligned particles to move within the enclosure, the material moving in response to contact with the moving particles.

In accordance with another embodiment of the invention, apparatus for facilitating translation of torque between first and second members, comprises: a field-responsive fluid including a plurality of particles suspended in a base fluid; and at least one fluid circulation feature operative in response to relative motion of the first member with respect to the second member to cause a portion of the field-responsive fluid, including at least some of the suspended particles, to be redistributed in a volume defined between the first and second members.

In accordance with another embodiment of the invention, a method for moving a material within an enclosure comprises: manipulating a field-responsive fluid including a plurality of particles suspended in a base fluid in the enclosure by generating a field, in response to which at least some of the plurality of particles align, and moving the field relative to the enclosure, thereby causing the aligned particles to move within the enclosure, the material moving in response to contact with the moving particles.

In accordance with another embodiment of the invention, a method for facilitating translation of torque between first and second members with a field-responsive fluid including a plurality of particles suspended in a base fluid, comprises: in response to relative motion of the first member with respect to the second member, causing a portion of the field-responsive fluid, including at least some of the suspended particles, to be redistributed in a volume defined between the first and second members.

### BRIEF DESCRIPTION OF THE FIGURES

FIG. 1 illustrates a wellsite system in which the present invention can be employed.

FIG. 2 illustrates the response of a magnetorheological fluid to an applied field.

FIG. 3 illustrates actuation cause by accelerated particles.

FIG. 4 illustrates actuation caused by chains of particles.

FIG. 5 illustrates a magnetorheological fluid pump.

FIGS. 6a-6d illustrate a reciprocating magnetorheological fluid pump.

FIG. 7 illustrates a magnetorheological fluid clutch.

FIG. 8 illustrates fluid circulation features of the clutch of FIG. 7.

FIG. 9 illustrates an alternative embodiment of the fluid circulation features of the clutch of FIG. 7.

### DETAILED DESCRIPTION

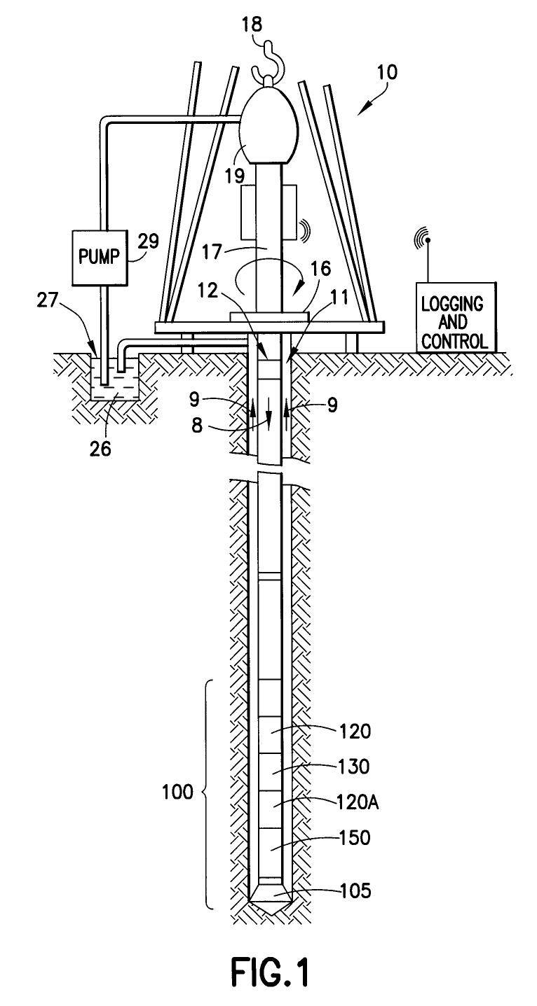

FIG. 1 illustrates a wellsite system in which the present invention can be employed. The wellsite can be onshore or offshore. In this exemplary system, a borehole (11) is formed in subsurface formations by rotary drilling in a manner that is well known. Embodiments of the invention can also use directional drilling, as will be described hereinafter.

A drill string (12) is suspended within the borehole (11) and has a bottom hole assembly (100) which includes a drill bit (105) at its lower end. The surface system includes platform and derrick assembly (10) positioned over the borehole (11), the assembly (10) including a rotary table (16), kelly (17), hook (18) and rotary swivel (19). The drill string (12) is rotated by the rotary table (16), energized by means not shown, which engages the kelly (17) at the upper end of the drill string. The drill string (12) is suspended from a hook (18), attached to a traveling block (also not shown), through the kelly (17) and a rotary swivel (19) which permits rotation of the drill string relative to the hook. As is well known, a top drive system could alternatively be used.

In the example of this embodiment, the surface system further includes drilling fluid or mud (26) stored in a pit (27) formed at the well site. A pump (29) delivers the drilling fluid (26) to the interior of the drill string (12) via a port in the swivel (19), causing the drilling fluid to flow downwardly through the drill string (12) as indicated by the directional arrow (8). The drilling fluid exits the drill string (12) via ports in the drill bit (105), and then circulates upwardly through the annulus region between the outside of the drill string and the wall of the borehole, as indicated by the directional arrows (9). In this well known manner, the drilling fluid lubricates the drill bit (105) and carries formation cuttings up to the surface as it is returned to the pit (27) for recirculation.

The bottom hole assembly (100) of the illustrated embodiment includes a logging-while-drilling (LWD) module (120), a measuring-while-drilling (MWD) module (130), a roto-steerable system and motor, and drill bit (105).

The LWD module (120) is housed in a special type of drill collar, as is known in the art, and can contain one or a plurality of known types of logging tools. It will also be understood that more than one LWD and/or MWD module can be employed, e.g. as represented at (120A). (References, throughout, to a module at the position of (120) can alternatively mean a module at the position of (120A) as well.) The LWD module includes capabilities for measuring, processing, and storing information, as well as for communicating with the surface equipment. In the present embodiment, the LWD module includes a pressure measuring device.

The MWD module (130) is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

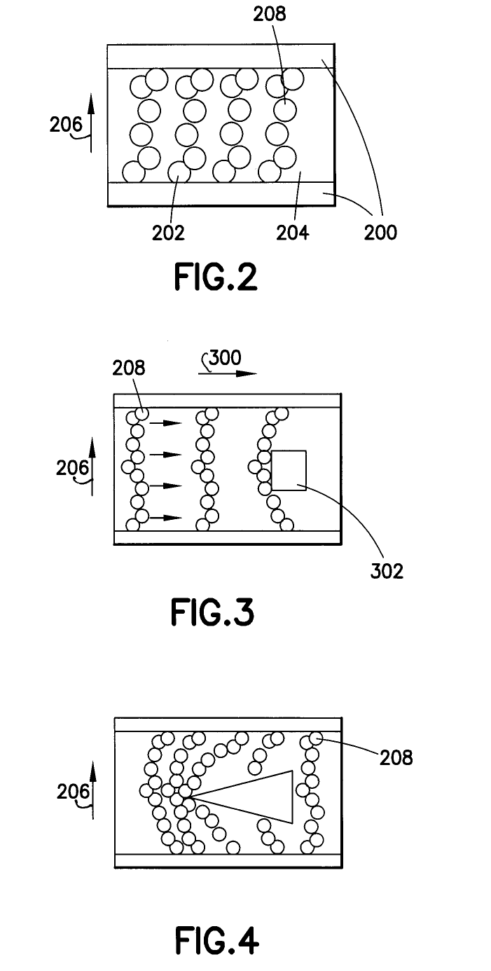

FIG. 2 illustrates operation of the fluid (26) within a conduit (200) such as drill string (12) of FIG. 1 in greater detail. The fluid (26) is a field-responsive fluid including magnetically or electrically responsive particles (202) suspended in a base fluid (204). An additive may be used to assist in suspending the particles and preventing agglomeration. For clarity of explanation, a magnetorheological fluid will be described hereafter. In the absence of a magnetic field the magnetorheological fluid behaves similar to a Newtonian fluid. However, in the presence of magnetic field (206) the particles (202) suspended in the base fluid (204) align and form chains (208) which are roughly parallel to the magnetic lines of flux associated with the magnetic field. When activated in this manner by a magnetic field, the magnetorheological fluid is in a semi-solid state which exhibits increased resistance to shear. In particular, resistance to shear is increased due to the magnetic attraction between particles of the chains.

As will be explained in greater detail below, field-responsive fluids can be utilized at a wellsite for applications associated with drilling, completion, production, and other tasks. Further, the fluids can be used to generate active force. The ability to generate active force, in contrast with resistive force, enables field-responsive fluids to be used in a variety of new applications, including but not limited to pumps. Further, fluid circulating features may be utilized to mitigate agglomeration.

Referring to FIG. 3, one aspect of active force generation with a magnetorheological fluid is an applied force exerted on an object by collision with accelerated particles. As already described, application of a magnetic field (206) causes the particles to align relative to one another and form distinct chains (208) of particles. Moving the applied magnetic field relative to the fluid enclosure causes the chains of particles to accelerate in the direction (300) in which the magnetic field is moved, unless blocked by the enclosure. If a non-magnetic object (302) is located in the fluid enclosure, at least some of the particles in the chains collide with the object. The collision of the particles with the object results in exertion of force on the object. The effect of the exerted force is a function of the angle of incidence of the particle on the object and the magnitude of the force. In the case where the particle collides with a planar surface of the object at an angle of 90°, the exerted force is in the direction of movement in the particle with a magnitude equal to the product of particle mass and acceleration. The shape of the object should therefore be considered when it is desirable to achieve a particular result.

Referring to FIG. 4, another aspect of active force generation with a magnetorheological fluid is an applied force exerted on an object by the chains of accelerated particles. As already described, application of a magnetic field causes the particles to align relative to one another and form distinct chains (208) of particles. Moving the applied magnetic field relative to the fluid enclosure causes the chains of particles to accelerate in the direction in which the magnetic field is moved. As the particles contact and move past a non-magnetic object in the enclosure, an opening forms in the particle chain beginning at the leading edge of the object. Because the applied magnetic force continues to cause attraction between particles on opposite sides of the opening within a given line of flux, a frictional force is exerted on the object by groups of attracting particles in contact with the object. In the illustrated example the force is exerted on the forward slanted surfaces, but not on the planar surface.

Referring to FIG. 5, magnetorheological fluid can be used to form a positive displacement pump. A magnetic field characterized by lines of flux (500) is applied to a magnetorheological fluid, causing particles to align and form chains. Adjacent chains of particles combine to form walls (502). Because spaces between adjacent particles are small, fluid flow through the walls is inhibited. Moving the applied magnetic field relative to the fluid enclosure causes the walls of particles to accelerate in the direction in which the magnetic field is moved. Because fluid flow through the walls is inhibited, a net positive amount of fluid is moved by the wall. In other words, the fluid is pumped by the movement of the magnetic field as applied to the fluid through the particle walls.

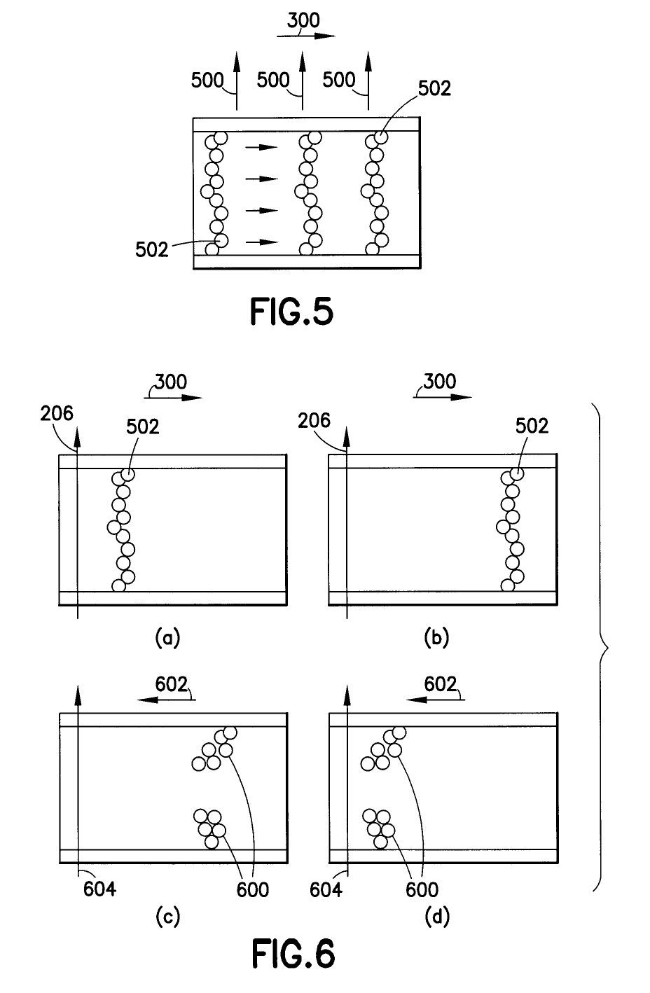

Referring to FIGS. 6a through 6d, magnetorheological fluid can be used to form a reciprocating positive displacement pump. As shown in FIG. 6a, a magnetic field (206) is applied to a magnetorheological fluid in a starting position, causing particles to align and form chains. Adjacent chains of particles combine to form a wall (502). Because spaces between adjacent particles are small, fluid flow through the walls is inhibited. Moving the applied magnetic field in direction (300) relative to the fluid enclosure causes the walls of particles to accelerate in the same direction in which the magnetic field is moved. Because fluid flow through the walls is inhibited, a net positive amount of fluid is moved by the wall (502) between the starting position (FIG. 6a) and an ending position (FIG. 6b). In other words, FIGS. 6a and 6b illustrate a pump stroke. As shown in FIGS. 6c and 6d, a reset stroke is implemented by unforming the wall to create loose associations of particles (600) and moving the particles in a reverse direction (602) from the ending position back to the starting position. The wall is unformed by manipulation of the applied magnetic field. For example, the magnitude of the applied magnetic field may be reduced, creating a modified applied field (604). The loosely associated particles (600) are then returned to the starting position by moving the magnetic field (604) in a direction (602) from the ending position to the starting position. The wall is then reformed from the loosely associated particles by increasing the magnitude of the magnetic field to create applied field (206) as shown in FIG. 6a. The cycle is repeated to provide pumping action.

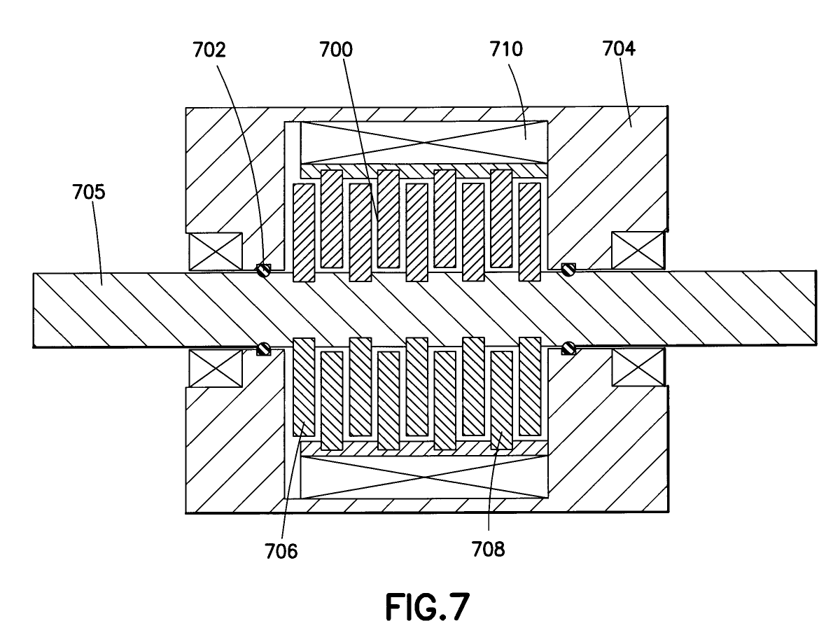

Referring now to FIG. 7, certain brakes, clutches, centrifugal pumps and other devices utilize field responsive fluids to control translation of torque between components in relative motion. One of the components is typically stationary in the case of brakes, whereas both components are typically rotatable in the case of clutches. In the illustrated example, a magnetorheological fluid clutch, the fluid is enclosed in a chamber (700) defined between two seals (702) and a housing (704). The fluid is used to translate force between two sets of plates: shaft (705)-coupled plates (706) and housing-coupled plates (708). The plates are disposed in alternating fashion such that no two plates of the same set are directly adjacent. The fluid in the gaps between adjacent plates is under shear when the shaft rotates with respect to the housing. An electromagnetic coil (710) is used to generate a magnetic field across the gaps. In the presence of the magnetic field fluid shear strength increases, thereby resisting the relative motion between adjacent plates. This results in torque loads on the shaft (705) and housing. Rotation of the plates also causes rotational fluid flow resulting in centrifugal force. Further, if unchecked, a body force applied as a result of the centrifugal force tends to cause the distribution of particles in the fluid to become non-uniform. In particular, because the particles typically have greater density than the base fluid, the particles tend to migrate away from the axis of rotation and agglomerate near the housing wall.

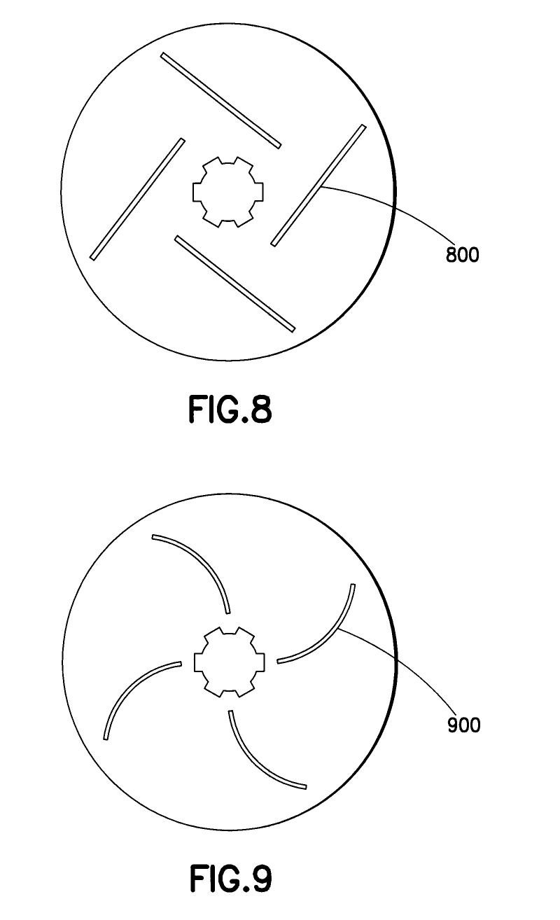

FIGS. 8 and 9 illustrate fluid circulation features (800, 900) which may be used to mitigate particle migration away from the axis of rotation. The fluid circulation features are disposed on rotating components such as discs and plates (706, 708, FIG. 7) and function to redirect fluid flow. A hole is provided in the center of the plate to accommodate the shaft. In operation, the plate rotates around an axis defined by the hole. The fluid circulation features may include protrusions, blind grooves and grooves cut through the plate between endpoints. In the illustrated example the features have linear or curvilinear geometry, and are defined between an endpoint proximate to the hole and an endpoint proximate to the outer edge of the plate. Further, the two points are axially offset with respect to each other. However, the illustrated geometries are not intended to be limiting. If the circulation features are defined in terms of polar coordinates centered in the shaft axis, any geometry that follows a locus that changes in radial distance from the center as the angle is changed might be utilized. As the plate rotates with respect to an adjacent plate, a portion of the fluid (including suspended particles) in the gap between the plates is forced either toward the axis of rotation or toward the outer edge of the plate depending on the direction of rotation relative to the offset angle of the end points of the fluid circulating features. In the case where agglomeration of particles proximate to the outer edge of the plate is desired, the offset angle is selected such that the fluid circulation features direct fluid inward toward the axis of rotation. Thus, particles that are migrating toward the outer edge of the plate are redirected with the fluid toward the axis of rotation, thereby mitigation particle agglomeration and promoting maintenance of more homogenous particle distribution in the gap.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for moving a material within an enclosure comprising:
a field-responsive fluid including a plurality of particles suspended in a base fluid, the field-responsive fluid disposed in the enclosure;
a field generating source which generates a field in response to which at least some of the plurality of particles align, the field being moved relative to the enclosure and thereby cause the align ed particles to move within the enclosure, the material moving in response to contact with the moving particles.

2. The apparatus of claim 1 wherein the field-responsive fluid is selected from the group consisting of: magnetorheological fluid and electrorheological fluid.

3. The apparatus of claim 1 wherein the field is represented by lines of flux, the particles aligning parallel to the lines of flux, and moving with the lines of flux.

4. The apparatus of claim 1 wherein the material is a non-magnetic object.

5. The apparatus of claim 1 wherein the material is a dielectric.

6. The apparatus of claim 1 wherein the material is fluid disposed between chains of aligned particles.

7. The apparatus of claim 1 wherein the field is applied to the particles at a starting position, causing at least some of the particles to align and form chains, the applied field is moved relative to the fluid enclosure from the start position to an end position, causing the walls of particles to move to the end position, the field is adjusted, allowing the particles to cease being aligned, and the adjusted field is moved from the end position to the start position, causing at least some of the unaligned particles to move from the end position to the start position.

8. Apparatus for facilitating translation of torque between first and second members, comprising:
a field-responsive fluid including a plurality of particles suspended in a base fluid; and
at least one fluid circulation feature operative in response to relative motion of the first member with respect to the second member to cause a portion of the field-responsive fluid, including at least some of the suspended particles, to be redistributed in a volume defined between the first and second members.

9. The apparatus of claim 8 wherein the first member rotates around an axis, and the fluid circulation feature causes the portion of field-responsive fluid to move toward the axis of rotation.

10. The apparatus of claim 8 wherein the first member rotates around an axis, and the fluid circulation feature causes the portion of field-responsive fluid to move away from the axis of rotation.

11. The apparatus of claim 8 wherein the fluid circulation feature is disposed on the first member, and includes at least one of: protrusions, blind grooves and grooves cut through the first member.

12. The apparatus of claim 11 wherein the first member rotates around an axis, and the circulation feature, relative to polar coordinates centered in the axis, follows a locus that changes in radial distance from the axis as the angle is changed.

13. A method for moving a material within an enclosure comprising:
manipulating a field-responsive fluid including a plurality of particles suspended in a base fluid in the enclosure by generating a field, in response to which at least some of the plurality of particles align, and moving the field relative to the enclosure, thereby causing the aligned particles to move within the enclosure, the material moving in response to contact with the moving particles.

14. The method of claim 13 wherein the field is represented by lines of flux, the particles aligning parallel to the lines of flux, and moving with the lines of flux, and including the step of moving the field.

15. The method of claim 13 including moving a non-magnetic object material.

16. The apparatus of claim 13 including moving a dielectric object material.

17. The method of claim 13 including moving fluid material disposed between chains of aligned particles.

18. The method of claim 13 including applying the field to the particles at a starting position, causing at least some of the particles to align and form chains, moving the applied field relative to the fluid enclosure from the start position to an end position, causing the walls of particles to move to the end position, adjusting the field, thereby allowing the particles to cease being aligned, and moving the adjusted field from the end position to the start position, causing at least some of the unaligned particles to move from the end position to the start position.

19. A method for facilitating translation of torque between first and second members with a field-responsive fluid including a plurality of particles suspended in a base fluid, comprising:
in response to relative motion of the first member with respect to the second member, causing a portion of the field-responsive fluid, including at least some of the suspended particles, to be redistributed in a volume defined between the first and second members.

20. The method of claim 19 including rotating the first member around an axis, and the fluid circulation feature causing the portion of field-responsive fluid to move toward the axis of rotation.

21. The method of claim 19 including rotating the first member around an axis, and the fluid circulation feature causing the portion of field-responsive fluid to move away from the axis of rotation.

22. The method of claim 19 wherein the fluid circulation feature is disposed on the first member, and including moving particles with at least one of: protrusions, blind grooves and grooves cut through the first member.

23. The method of claim 19 including rotating the first member around an axis, and moving particles with a circulation feature characterized, relative to polar coordinates centered in the axis, as following a locus that changes in radial distance from the axis as the angle is changed.
